(19) United States
(12) Patent Application Publication
(10) Pub. No.: US 2017/0160952 A1
(43) Pub. Date: Jun. 8, 2017

(54) MEMORY CONTROLLER, MEMORY SYSTEM, AND INFORMATION PROCESSING SYSTEM

(71) Applicant: SONY CORPORATION, TOKYO (JP)

(72) Inventors: KENICHI NAKANISHI, TOKYO (JP); HIROYUKI IWAKI, KANAGAWA (JP); KEN ISHII, TOKYO (JP); RYOJI IKEGAYA, KANAGAWA (JP); KENTAROU MORI, KANAGAWA (JP)

(21) Appl. No.: 15/323,810

(22) PCT Filed: Jun. 9, 2015
(86) PCT No.: PCT/JP2015/066577

§ 371 Date: Jan. 4, 2017

(30) Foreign Application Priority Data
Jul. 28, 2014 (JP) 2014-153139

(51) Int. Cl. G06F 3/06; G06F 12/14; G06F 11/10; G06F 13/40

(52) U.S. Cl. CPC G06F 3/0611; G06F 3/0614; G06F 3/0623; G06F 3/0647; G06F 3/0679; G06F 13/4022; G06F 12/1408; G06F 11/1044; G06F 2212/402

(57) ABSTRACT

A latency time of memory access is suppressed.

A memory controller includes memory control units and a connection switching unit. The memory control units each independently generate a request to a memory on the basis of a command from a computer. Any one of the memory control units and the memory are connected in response to a connection request from each of the memory control units, and the request is output to the memory. A memory system is constituted of the memory and the memory controller. An information processing system is constituted of the memory system and the computer.

### CROSS REFERENCE TO RELATED APPLICATIONS

This application is a U.S. National Phase of International Patent Application No. PCT/JP2015/066577 filed on Jun. 9, 2015, which claims priority benefit of Japanese Patent Application No. JP 2014-153139 filed in the Japan Patent Office on Jul. 28, 2014. Each of the above-referenced applications is hereby incorporated herein by reference in its entirety.

### TECHNICAL FIELD

The present technology relates to a memory controller that controls a memory. Specifically, the present technology relates to a memory controller, a memory system, and an information processing system that generate a request to a memory on the basis of a command issued from a computer.

### BACKGROUND ART

Non-volatile memories typified by a flash memory, a phase change random access memory, a resistive random access memory, and the like can perform access in which a page having the size of several bytes is regarded as a read or write access unit. A non-volatile memory controller that controls the non-volatile memory uses an ECC (Error Correcting Code) so as to improve reliability of data stored in the non-volatile memory. In other words, at the time of write, an ECC code is added to data received from a host computer and then stored, and at the time of read, a bit error is detected by the ECC code and the data subjected to error correction is output to the host computer. Therefore, a processing time for a read command from the host computer is determined by a value obtained by adding a busy time and a data transfer time spent for reading the data from the non-volatile memory to a processing time necessary for ECC detection processing and ECC correction processing when the data is received. Further, a processing time for a write request from the host is determined by a value obtained by adding a busy time spent for data transfer to and data write in the non-volatile memory to a processing time necessary for ECC generation processing. The non-volatile memory controller sequentially processes commands, which are received from the host computer, with respect to one non-volatile memory. When a write command is issued subsequently to a read command, the processing time is obtained by adding a processing time for a read request and a processing time for write.

When the read command and the write command are successively generated to the non-volatile memory, both the commands are sequentially processed. Thus, until the ECC detection processing and the ECC correction processing are completed and the transfer of read data is completed, the next write command cannot be received. After the transfer of the read data is completed and the write command and data are received, the ECC generation processing is performed. Thus, after the data is transferred by read from the non-volatile memory and before the transfer of write data to the non-volatile memory is started, a latency time occurs, in which data is not transferred. The latency time causes reduced performance of a non-volatile storage apparatus in terms of the host computer, and inhibits the originally high-speed performance of the non-volatile memory from being exerted. In contrast to this, there is proposed a system in which, when a plurality of commands is generated as described above, the commands are rearranged to suppress occurrence of switching between read and write, and performance is thus prevented from being reduced (see, for example, Patent Literature 1).

### CITATION LIST

### Patent Literature

Patent Literature 1: Japanese Patent Application Laid-open No. 2009-157886

### DISCLOSURE OF INVENTION

### Technical Problem

In the related art described above, it is possible to suppress the occurrence of switching between read and write by rearranging the commands. However, in order to rearrange the commands, after the plurality of commands is received, it is necessary to perform processing of determining whether each command is a command capable of being rearranged and processing of rearranging the commands according to the determination, and then start access to the non-volatile memory. As a result, such processing itself becomes a cause that delays a start timing of the access to the non-volatile memory.

The present technology has been made in view of the circumstances described above and it is an object of the present technology to suppress a latency time of memory access without rearranging commands.

### Solution to Problem

The present technology has been made to solve the above-mentioned problems, and according to a first aspect thereof, there is provided a memory controller including: memory control units that each independently generate a request to a memory on the basis of a command from a computer; and a connection switching unit that connects any one of the memory control units and the memory in response to a connection request from each of the memory control units and outputs the request to the memory. This provides an action to suppress a latency time of memory access by independently processing a plurality of requests.

Further, in the first aspect, each of the memory control units may include a read control unit that generates, as the request, a read request to the memory, and a read data reception unit that receives read data from the memory, the read data corresponding to the read request. Further, in this case, each of the memory control units may further include a read data processing unit that performs predetermined data processing on the read data.

Further, in this case, the read data processing unit may perform, as the predetermined data processing, error detection/correction processing of the read data or decryption processing of the read data.

Further, in the first aspect, each of the memory control units may include a write control unit that generates, as the request, a write request to the memory, and a write data transmission unit that transmits write data to the memory, the write data being related to the write request. Further, in this case, each of the memory control units may further include a write data processing unit that performs predetermined data processing on the write data.

Further, in this case, the write data processing unit may perform, as the predetermined data processing, generation of an error correcting code of the write data or encryption processing of the write data.

Further, in the first aspect, each of the memory control units may include any one of: a read control unit that generates, as the request, a read request to the memory, and a read data reception unit that receives read data from the memory, the read data corresponding to the read request; and a write control unit that generates, as the request, a write request to the memory, and a write data transmission unit that transmits write data to the memory, the write data being related to the write request.

Further, according to a second aspect of the present technology, there is provided a memory system including: a memory; memory control units that each independently generate a request to the memory on the basis of a command from a computer; and a connection switching unit that connects any one of the memory control units and the memory in response to a connection request from each of the memory control units and outputs the request to the memory. This provides an action to suppress a latency time of memory access by independently processing requests to the memory.

Further, according to a third aspect of the present technology, there is provided an information processing system including: a memory; a computer; memory control units that each independently generate a request to the memory on the basis of a command from the computer; and a connection switching unit that connects any one of the memory control units and the memory in response to a connection request from each of the memory control units and outputs the request to the memory. This provides an action to suppress a latency time of memory access by independently processing requests to the memory from the computer.

### Advantageous Effects of Invention

According to the present technology, an optimal effect capable of suppressing a latency time of memory access without rearranging commands can be produced. It should be noted that the effects described herein are not necessarily limited and may be any one of the effects described in this disclosure.

### BRIEF DESCRIPTION OF DRAWINGS

FIG. 1 is a diagram showing one configuration example of an information processing system in an embodiment of the present technology.

FIG. 2 is a diagram showing one configuration example of a memory controller 200 in a first embodiment of the present technology.

FIG. 3 is a diagram showing examples of signal lines of a memory control engine 201 in the first embodiment of the present technology.

FIG. 4 is a diagram showing a configuration example of a memory control unit 250 in the first embodiment of the present technology.

FIG. 5 is a sequence diagram showing a processing procedure example of a storage interface control unit 210 in the first embodiment of the present technology.

FIG. 6 is a sequence diagram showing a processing procedure example of the memory control engine 201 in the first embodiment of the present technology.

FIGS. 7a and 7b are a diagram showing operation timing examples of the memory controller 200 in the first embodiment of the present technology.

FIG. 8 is a diagram showing a configuration example of a connection switching unit 260 in the first embodiment of the present technology.

FIG. 9 is a sequence diagram showing a processing procedure example of the connection switching unit 260 in the first embodiment of the present technology.

FIG. 10 is a diagram showing a first operation timing example of the connection switching unit 260 in the first embodiment of the present technology.

FIG. 11 is a diagram showing a second operation timing example of the connection switching unit 260 in the first embodiment of the present technology.

FIG. 12 is a diagram showing a configuration example of a memory control engine 201 in a second embodiment of the present technology.

FIG. 13 is a diagram showing a configuration example of a memory read control unit 280-1 in the second embodiment of the present technology.

FIG. 14 is a diagram showing a configuration example of a memory write control unit 280-2 in the second embodiment of the present technology.

FIG. 15 is a sequence diagram showing a first processing procedure example of a storage interface control unit 210 in the second embodiment of the present technology.

FIG. 16 is a sequence diagram showing a second processing procedure example of the storage interface control unit 210 in the second embodiment of the present technology.

FIG. 17 is a sequence diagram showing a processing procedure example of a connection switching unit 260 in the second embodiment of the present technology.

FIG. 18 is a diagram showing a configuration example of a memory control engine 201 in a third embodiment of the present technology.

FIG. 19 is a diagram showing a configuration example of a memory control engine 202 in a fourth embodiment of the present technology.

FIG. 20 is the first half of a sequence diagram showing a processing procedure example of a connection switching unit 260 in the fourth embodiment of the present technology.

FIG. 21 is the second half of the sequence diagram showing the processing procedure example of the connection switching unit 260 in the fourth embodiment of the present technology.

FIG. 22 is a diagram showing an operation timing example of the connection switching unit 260 in the fourth embodiment of the present technology.

FIG. 23 is a diagram showing a configuration example of a memory control unit 250 in a fifth embodiment of the present technology.

### MODE(S) FOR CARRYING OUT THE INVENTION

Hereinafter, modes for carrying out the present technology (hereinafter, described as embodiment) will be described. Description will be given by the following order.

1. First Embodiment (example of providing two memory controllers)
2. Second Embodiment (example of providing memory controller specifically for read control and memory controller specifically for write control)
3. Third Embodiment (example of providing three or more memory controllers)
4. Fourth Embodiment (example assuming plurality of memory dies)
5. Fifth Embodiment (example of performing encryption and decryption processing in memory controller)

### 1. First Embodiment

[Configuration of Information Processing System]

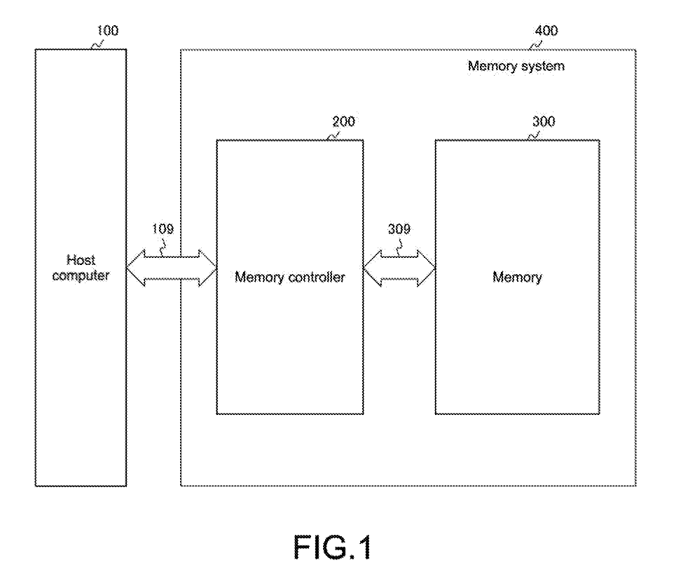

FIG. 1 is a diagram showing one configuration example of an information processing system in an embodiment of the present technology. The information processing system includes a host computer 100, a memory controller 200, and a memory 300. The memory controller 200 and the memory 300 form a memory system 400.

The host computer 100 issues a command to order data read processing, data write processing, and the like with respect to the memory 300. The host computer 100 includes a processor (not shown) that executes processing to serve as the host computer 100, and a controller interface (not shown) for performing a transaction with the memory controller 200. Further, the host computer 100 generally includes a data buffer. The host computer 100 and the memory controller 200 are connected to each other via a signal line 109. It should be noted that the host computer 100 is an example of a computer described in the Claims.

The memory controller 200 performs request control to the memory 300 according to a command from the host computer 100. The memory controller 200 and the memory 300 are connected to each other via a signal line 309.

The memory 300 includes a control unit and a memory cell array (not shown). The control unit of the memory 300 accesses a memory cell according to a request from the memory controller 200. The memory cell array of the memory 300 is a memory cell array formed of a plurality of memory cells. The memory cell array includes many memory cells that store any of two values for each bit or store any of multiple values for every several bits. The many memory cells are arrayed two-dimensionally (in a matrix). The memory cell array is assumed as a non-volatile memory (NVM) that can overwrite data without erase, with a page having the size of several bytes being an access unit for read or write.

[Configuration of Memory Controller]

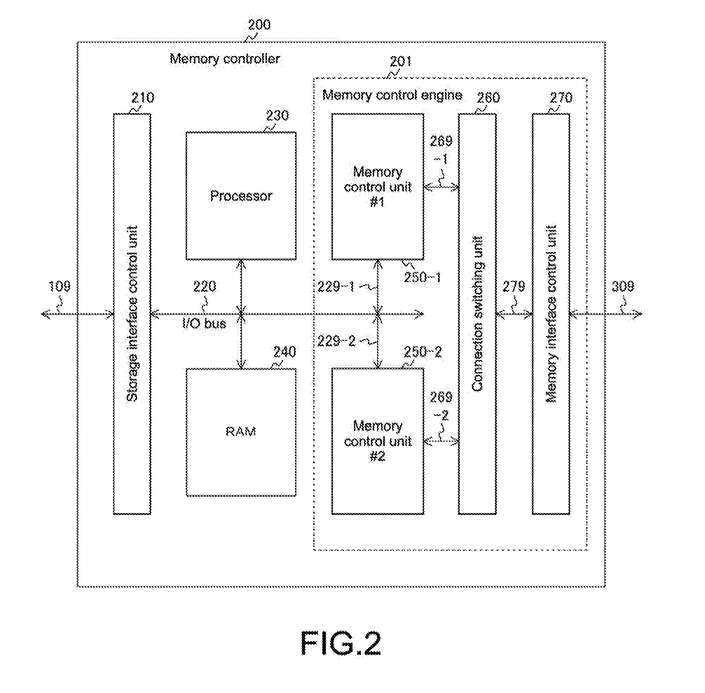

FIG. 2 is a diagram showing one configuration example of the memory controller 200 in the first embodiment of the present technology. The memory controller 200 includes a storage interface control unit 210, a processor 230, a RAM 240, and a memory control engine 201, which are connected to one another via an I/O bus 220.

The storage interface control unit 210 is connected to the host computer 100 via the signal line 109 and performs a transaction with the host computer 100. The storage interface control unit 210 specifically includes a general-purpose bus that is used as an interface widely used for storage, such as a USB, a SATA, and a PCIe. The storage interface control unit 210 has a function of supporting command queuing by which commands from the host computer 100 can be received at the same time. With this configuration, requests for accessing the memory 300 are transmitted at random, and read access and write access are performed.

The processor 230 performs processing necessary for an operation of the memory controller 200. The RAM 240 is a memory that stores data and the like necessary for the operation of the memory controller 200. The RAM 240 is also used as a data buffer. The memory control engine 201 performs request control to the memory 300.

In the first embodiment, the memory control engine 201 includes two memory control units 250-1 and 250-2, a connection switching unit 260, and a memory interface control unit 270.

The memory control units 250-1 and 250-2 (hereinafter, collectively described as memory control units 250 in some cases) independently perform request control to the memory 300. The memory control unit 250-1 is connected to the I/O bus 220 via a signal line 229-1 and connected to the connection switching unit 260 via a signal line 269-1. The memory control unit 250-2 is connected to the I/O bus 220 via a signal line 229-2 and connected to the connection switching unit 260 via a signal line 269-2. Hereinafter, the signal lines 229-1 and 229-2 may be collectively described as signal lines 229. Further, the signal lines 269-1 and 269-2 may be collectively described as signal lines 269.

The connection switching unit 260 performs switching to connect one of the memory control units 250-1 and 250-2 to the memory 300. The memory interface control unit 270 is connected to the connection switching unit 260 via a signal line 279 and performs a transaction with the memory 300.

It should be noted that the bandwidth of the I/O bus 220 is assumed to be larger than the bandwidth for read and write of the memory 300. Therefore, it is assumed that the performance of the memory 300 limits the performance of the memory system 400.

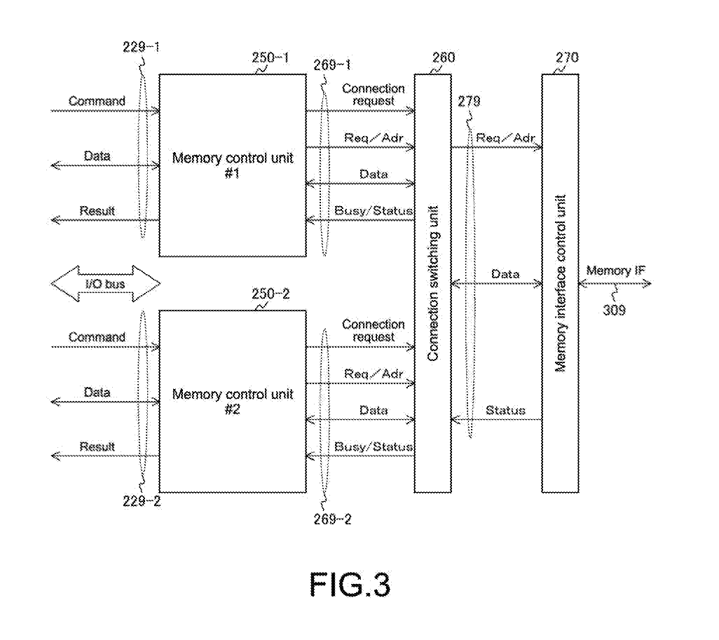

FIG. 3 is a diagram showing examples of signal lines of the memory control engine 201 in the first embodiment of the present technology.

The signal lines 229 between the memory control units 250 and the I/O bus 220 include command signal lines, data signal lines, and result signal lines. Further, the signal lines 269 between the memory control units 250 and the connection switching unit 260 include connection request signal lines, request address (Req/Adr) signal lines, data (Data) signal lines, and busy status (Busy/Status) signal lines. Further, the signal line 279 between the connection switching unit 260 and the memory interface control unit 270 includes a request address (Req/Adr) signal line, a data (Data) signal line, and a status (Status) signal line.

The storage interface control unit 210 alternately supplies a command, which is issued from the host computer 100, to the two memory control units 250-1 and 250-2. Each of the memory control units 250 receives the command issued from the host computer 100 and independently generates and controls a request to the memory 300. This can cause the memory control units 250 to operate in parallel, to suppress occurrence of a latency time in the memory interface control unit 270.

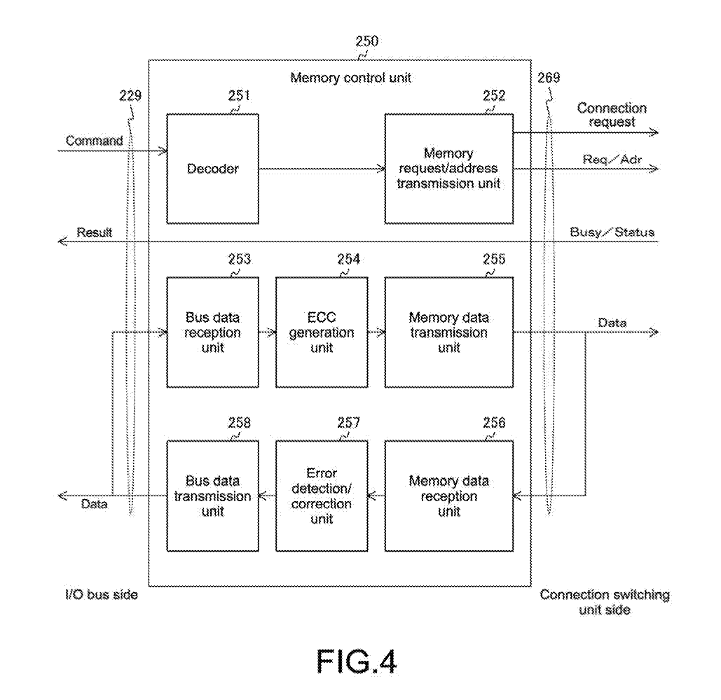

FIG. 4 is a diagram showing a configuration example of the memory control unit 250 in the first embodiment of the present technology. Each of the memory control units 250 includes a decoder 251 and a memory request/address transmission unit 252. Further, each of the memory control units 250 includes a bus data reception unit 253, an ECC generation unit 254, a memory data transmission unit 255, a memory data reception unit 256, an error detection/correction unit 257, and a bus data transmission unit 258.

The decoder 251 is a decoder that deciphers the command issued from the host computer 100. The memory request/address transmission unit 252 transmits a request and an address to the memory 300 according to a decoding result by the decoder 251. When transmitting a request and an address, before the transmission, the memory request/address transmission unit 252 outputs a connection request to the connection switching unit 260. It should be noted that the memory request/address transmission unit 252 is an example of a read control unit and a write control unit described in the Claims.

The bus data reception unit 253 receives write data from the I/O bus 220. The ECC generation unit 254 generates an ECC (Error Correcting Code) for the write data received by the bus data reception unit 253. It should be noted that the ECC generation unit 254 is an example of a write data processing unit described in the Claims.

The memory data transmission unit 255 transmits the write data and the ECC to the memory 300. It should be noted that the memory data transmission unit 255 is an example of a write data transmission unit described in the Claims.

The memory data reception unit 256 receives read data and an ECC that are read from the memory 300. The error detection/correction unit 257 performs error detection and error correction by the ECC on the read data received by the memory data reception unit 256. The bus data transmission unit 258 transmits the read data, which is output from the error detection/correction unit 257, to the I/O bus 220. It should be noted that the memory data reception unit 256 is an example of a read data reception unit described in the Claims. It should be noted that the error detection/correction unit 257 is an example of a read data processing unit described in the Claims.

[Operation of Memory Controller]

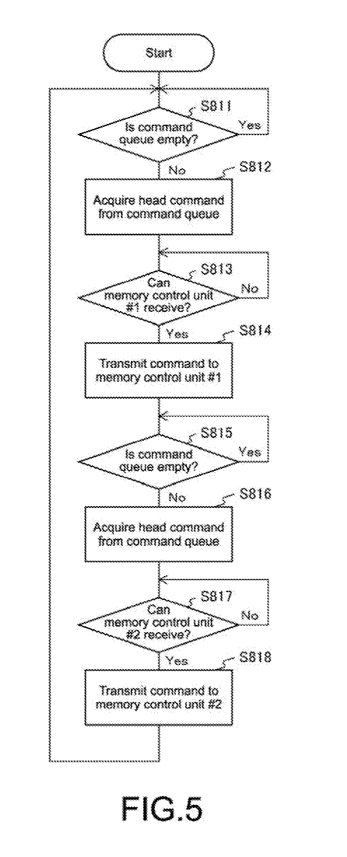

FIG. 5 is a sequence diagram showing a processing procedure example of the storage interface control unit 210 in the first embodiment of the present technology. Here, the storage interface control unit 210 includes one command queue of FIFO (First-In First-Out) for holding commands received from the host computer 100. In other words, a read command and a write command are held in the command queue in the received order and sequentially taken out from the command previously received.

When the command queue is empty, the storage interface control unit 210 waits without change (Step S811: Yes). When the command queue is not empty (Step S811: No), the storage interface control unit 210 acquires a head command from the command queue (Step S812). When a memory control unit #1 (250-1) enters a state capable of receiving the next command (Step S813: Yes), the storage interface control unit 210 transmits the command to the memory control unit #1 (250-1) (Step S814).

Subsequently, when the command queue is empty, the storage interface control unit 210 waits without change (Step S815: Yes). When the command queue is not empty (Step S815: No), the storage interface control unit 210 acquires a head command from the command queue (Step S816). When a memory control unit #2 (250-2) enters a state capable of receiving the next command (Step S817: Yes), the storage interface control unit 210 transmits the command to the memory control unit #2 (250-2) (Step S818).

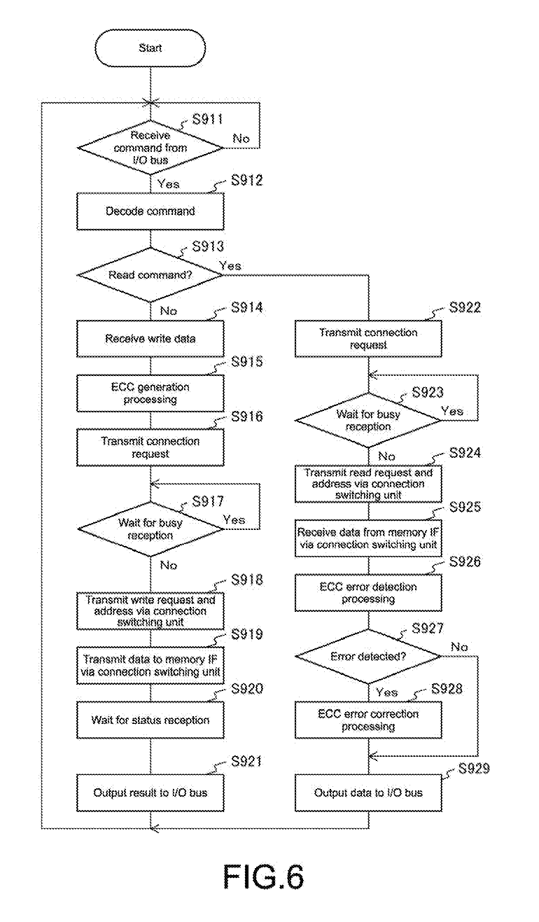

FIG. 6 is a sequence diagram showing a processing procedure example of the memory control engine 201 in the first embodiment of the present technology.

The decoder 251 of the memory control unit 250 receives the command, which is issued from the host computer 100, via the I/O bus 220 (Step S911) and decodes the command (Step S912). As a result, if the command is a read command, processing from Step S922 is executed (Step S913: Yes), and if the command is a write command, processing from Step S914 is executed (Step S913: No).

If the decoded command is a write command (Step S913: No), the bus data reception unit 253 receives write data (Step S914). Further, the ECC generation unit 254 generates an ECC for the write data (Step S915). The memory request/address transmission unit 252 then transmits a connection request to the connection switching unit 260 (Step S916). Subsequently, the memory control unit 250 waits for a busy signal from the connection switching unit 260 (Step S917). The busy signal means that the connection to the memory 300 is completed and the transfer to the memory 300 is available.

When the busy signal is output from the connection switching unit 260 (Step S917: No), the memory request/address transmission unit 252 transmits a write request and address via the connection switching unit 260 (Step S918). Further, the memory data transmission unit 255 transmits the write data via the connection switching unit 260 (Step S919). Subsequently, after waiting for status reception (Step S920), the result is output to the I/O bus 220 (Step S921).

If the decoded command is a read command (Step S913: Yes), the memory request/address transmission unit 252 transmits a connection request to the connection switching unit 260 (Step S922). Subsequently, the memory control unit 250 waits for a busy signal from the connection switching unit 260 (Step S923).

When the busy signal is output from the connection switching unit 260 (Step S923: No), the memory request/address transmission unit 252 transmits a read request and address via the connection switching unit 260 (Step S924). As a result, the memory data reception unit 256 receives the read data and the ECC via the connection switching unit 260 (Step S925).

The error detection/correction unit 257 then performs error detection of the read data by the ECC (Step S926). As a result, when an error is detected (Step S927: Yes), the error detection/correction unit 257 performs error correction of the read data by the ECC (Step S928). When an error is not detected (Step S927: No), error correction is unnecessary. The bus data transmission unit 258 then outputs the read data, which is output from the error detection/correction unit 257, to the I/O bus 220 (Step S929).

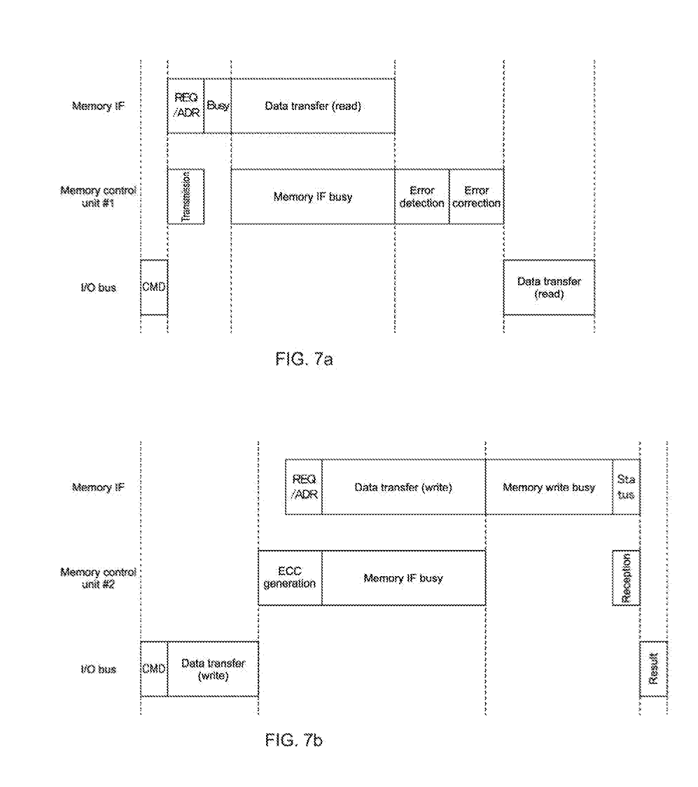

FIGS. 7a and 7b are a diagram showing operation timing examples of the memory controller 200 in the first embodiment of the present technology. FIG. 7a shows an operation example when the read command is received, and shows processing of Step S922 to S929 of the sequence diagram described above. FIG. 7b shows an operation example when the write command is received, and shows processing of Step S914 to S921 of the sequence diagram described above.

[Connection Switching Unit]

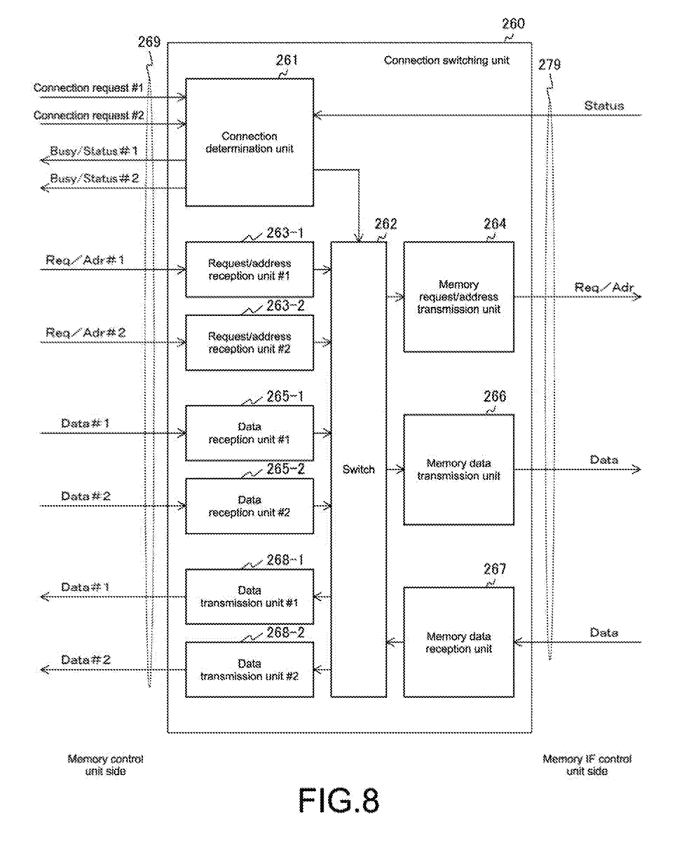

FIG. 8 is a diagram showing a configuration example of the connection switching unit 260 in the first embodiment of the present technology. The connection switching unit 260 includes a connection determination unit 261, a switch 262, request/address reception units 263-1 and 263-2 (hereinafter, collectively described as request/address reception units 263 in some cases), and a memory request/address transmission unit 264. Further, the connection switching unit 260 includes data reception units 265-1 and 265-2 (hereinafter, collectively described as data reception units 265 in some cases), and a memory data transmission unit 266. Furthermore, the connection switching unit 260 includes a memory data reception unit 267 and data transmission units 268-1 and 268-2 (hereinafter, collectively described as data transmission units 268 in some cases).

The connection determination unit 261 receives the connection requests from the memory control units 250 and determines which of the memory control units 250 is to be connected. The switch 262 is a switch that connects any of the memory control units 250 to the memory 300 side according to a determination result by the connection determination unit 261. Specifically, any of the request/address reception units 263 is connected to the memory request/address transmission unit 264, any of the data reception units 265 is connected to the memory data transmission unit 266, and any of the data transmission units 268 is connected to the memory data reception unit 267.

The request/address reception units 263 each receive the request and the address from the memory control unit 250. The memory request/address transmission unit 264 transmits the request and the address to the memory 300 side.

The data reception units 265 each receive the write data from the memory control unit 250. The memory data transmission unit 266 transmits the write data to the memory 300 side.

The memory data reception unit 267 receives the read data from the memory 300. The data transmission units 268 each transmit the read data to the memory control unit 250.

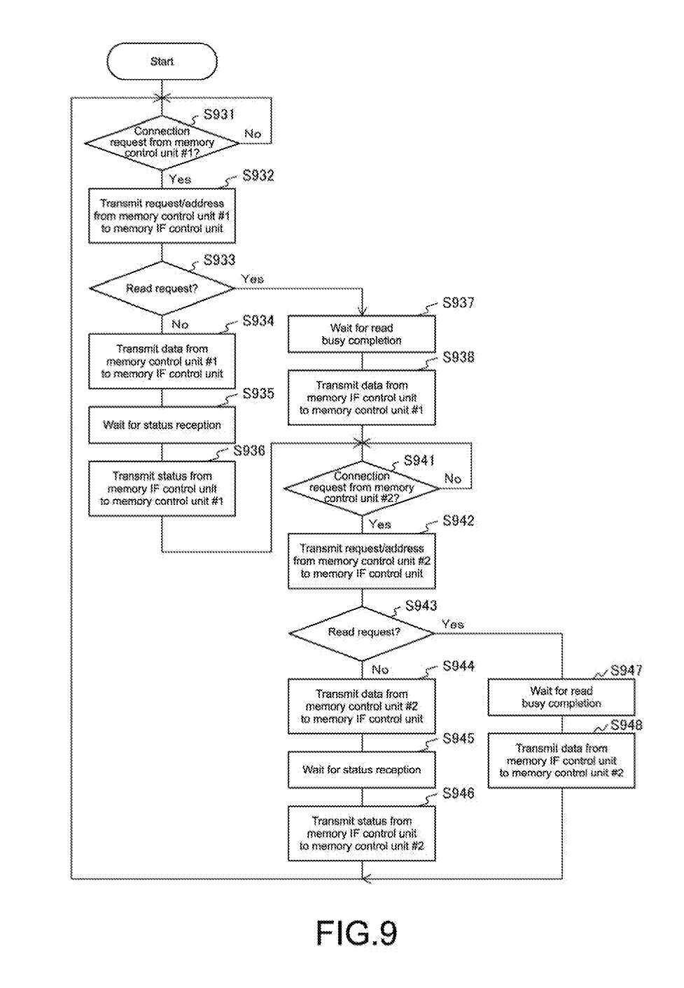

FIG. 9 is a sequence diagram showing a processing procedure example of the connection switching unit 260 in the first embodiment of the present technology.

First, when the connection determination unit 261 determines that the connection request from the memory control unit 250-1 is received (Step S931: Yes), the memory control unit 250-1 side of the switch 262 is selected. With this configuration, the request and address received from the memory control unit 250-1 by the request/address reception unit 263-1 are transmitted from the memory request/address transmission unit 264 to the memory interface control unit 270 (Step S932).

When the request from the memory control unit 250-1 is a read request (Step S933: Yes), the connection determination unit 261 waits for read busy completion (Step S937). Subsequently, the read data transmitted from the memory interface control unit 270 is received by the memory data reception unit 267 and transmitted to the memory control unit 250-1 via the data transmission unit 268-1 (Step S938).

When the request from the memory control unit 250-1 is a write request (Step S933: No), the write data transmitted from the memory control unit 250-1 is received by the data reception units 265-1. The write data is then transmitted to the memory interface control unit 270 via the memory data transmission unit 266 (Step S934). The connection determination unit 261 then waits for status reception from the memory interface control unit 270 (Step S935). Subsequently, when receiving a status from the memory interface control unit 270, the connection determination unit 261 transmits the status to the memory control unit 250-1 (Step S936).

Next, when the connection determination unit 261 determines that the connection request from the memory control unit 250-2 is received (Step S941: Yes), the memory control unit 250-2 side of the switch 262 is selected. With this configuration, the request and address received from the memory control unit 250-2 by the request/address reception unit 263-2 are transmitted from the memory request/address transmission unit 264 to the memory interface control unit 270 (Step S942).

When the request from the memory control unit 250-2 is a read request (Step S943: Yes), the connection determination unit 261 waits for read busy completion (Step S947). Subsequently, the read data transmitted from the memory interface control unit 270 is received by the memory data reception unit 267 and transmitted to the memory control unit 250-2 via the data transmission unit 268-2 (Step S948).

When the request from the memory control unit 250-2 is a write request (Step S943: No), the write data transmitted from the memory control unit 250-2 is received by the data reception units 265-2. The write data is then transmitted to the memory interface control unit 270 via the memory data transmission unit 266 (Step S944). The connection determination unit 261 then waits for status reception from the memory interface control unit 270 (Step S945). Subsequently, when receiving a status from the memory interface control unit 270, the connection determination unit 261 transmits the status to the memory control unit 250-2 (Step S946).

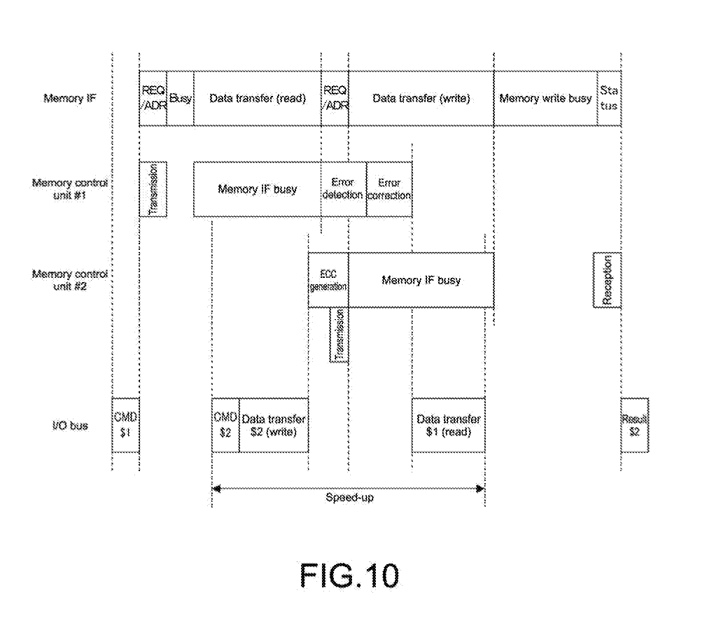

FIG. 10 is a diagram showing a first operation timing example of the connection switching unit 260 in the first embodiment of the present technology. This is an example of a case where a former command is a read command and a subsequent command is a write command.

The former read command is processed by the memory control unit 250-1. The read data received from the memory interface control unit 270 becomes a target subjected to error detection/correction by ECC and is output to the I/O bus 220.

The subsequent write command is processed by the memory control unit 250-2. ECC is generated for the write data input from the I/O bus 220, and is transmitted to the memory interface control unit 270. Subsequently, a status is output to the I/O bus 220 via the memory control unit 250-2.

The error detection processing and error correction processing performed in the memory control unit 250-1 are performed independently of the ECC generation processing performed in the operation of the memory control unit 250-2. The connection switching unit 260 thus makes adjustment such that collision does not occur in the memory interface control unit 270. Specifically, during that the memory control unit 250-1 is transferring data read from the memory 300, even if a connection request from the memory control unit 250-2 is received, the connection is maintained until the transfer of the read data is completed. During that time, the memory control unit 250-2 does not transmit data until the connection switching unit 260 is switched. As soon as the transfer by the memory control unit 250-1 is terminated, the connection switching unit 260 switches the connection according to the connection request from the memory control unit 250-2 and starts to transfer the write data for which an ECC code is prepared in the memory control unit 250-2. With this configuration, also when the read request and the write request are successive, a latency time does not occur in the memory interface control unit 270 and a high-speed memory system can be achieved.

At the center portion of the figure, read busy of the memory control unit 250-1 and write busy of the memory control unit 250-2 overlap with each other, so that the processing is performed at high speed. It is found that, in the memory interface control unit 270, except for the busy time, a latency time disappears and data transfer efficiency is improved.

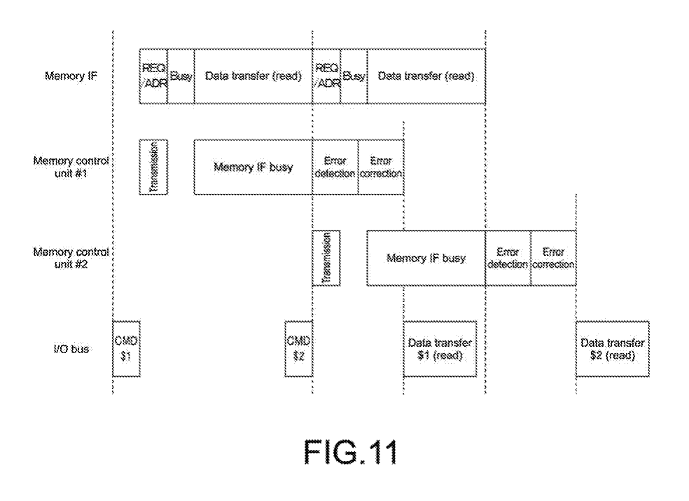

FIG. 11 is a diagram showing a second operation timing example of the connection switching unit 260 in the first embodiment of the present technology. This is an example of a case where a former command is a read command and a subsequent command is also a read command.

The former read command is processed by the memory control unit 250-1. The read data received from the memory interface control unit 270 becomes a target subjected to error detection/correction by ECC and is output to the I/O bus 220.

The subsequent read command is processed by the memory control unit 250-2. Similarly, the read data received from the memory interface control unit 270 becomes a target subjected to error detection/correction by ECC and is output to the I/O bus 220.

In this example, during that the error detection/correction of the read data is performed on the former read command, the read data is accessed for the subsequent read command. Therefore, the processing is performed at high speed in the overlapping period.

As described above, according to the first embodiment of the present technology, providing the two memory control units 250 that independently operate can resolve the latency time in the memory interface control unit 270 and can improve a random access speed of the memory 300.

### 2. Second Embodiment

In the first embodiment described above, the two memory control units are provided, but when functions of both the memory control units are dedicated to a read command and a write command, circuit sizes thereof can be reduced. In this regard, in a second embodiment, an example of providing a memory read control unit and a memory write control unit will be described. It should be noted that the whole information processing system is similar to that of the first embodiment, and description thereof will thus be omitted.

[Configuration of Memory Controller]

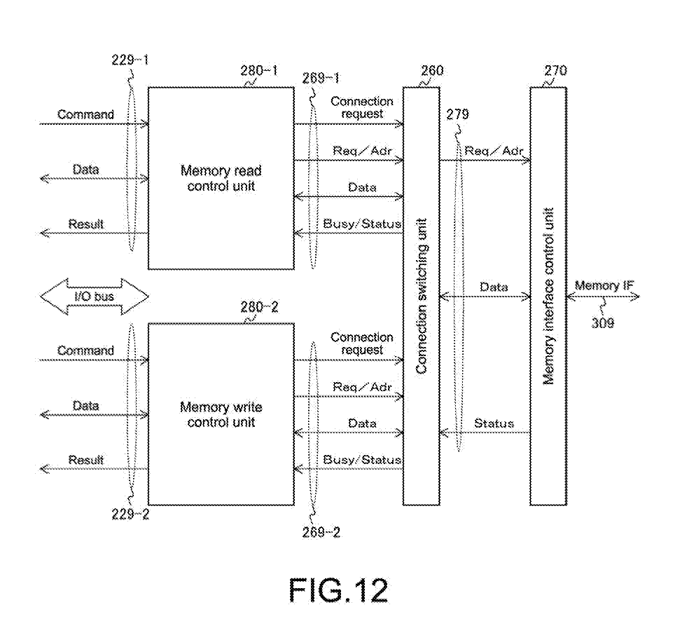

FIG. 12 is a diagram showing a configuration example of a memory control engine 201 in the second embodiment of the present technology. The memory control engine 201 in the second embodiment is obtained by replacing the memory control units 250-1 and 250-2 of the first embodiment with a memory read control unit 280-1 and a memory write control unit 280-2, respectively.

The memory read control unit 280-1 performs request control to the memory 300 on the read command. The memory write control unit 280-2 performs request control to the memory 300 on the write command.

It should be noted that the memory read control unit 280-1 and the memory write control unit 280-2 are each an example of a memory control unit described in the Claims.

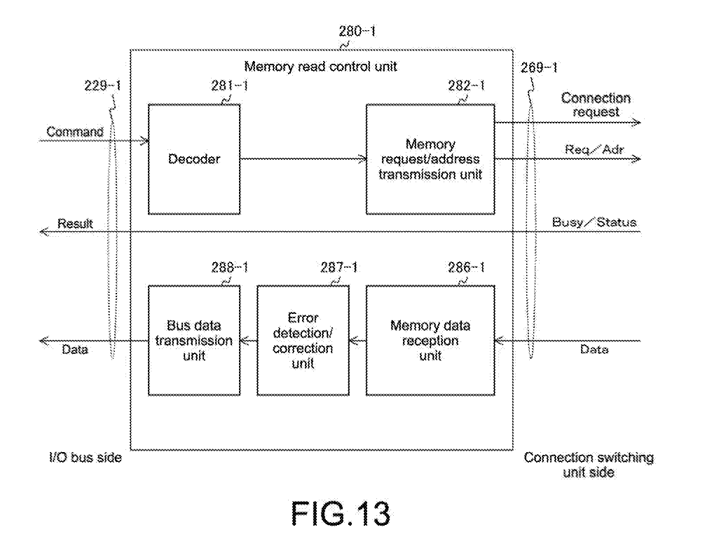

FIG. 13 is a diagram showing a configuration example of the memory read control unit 280-1 in the second embodiment of the present technology. The memory read control unit 280-1 includes a decoder 281-1, a memory request/address transmission unit 282-1, a memory data reception unit 286-1, an error detection/correction unit 287-1, and a bus data transmission unit 288-1.

The units of the memory read control unit 280-1 have similar functions to the decoder 251, the memory request/address transmission unit 252, the memory data reception unit 256, the error detection/correction unit 257, and the bus data transmission unit 258 in the first embodiment.

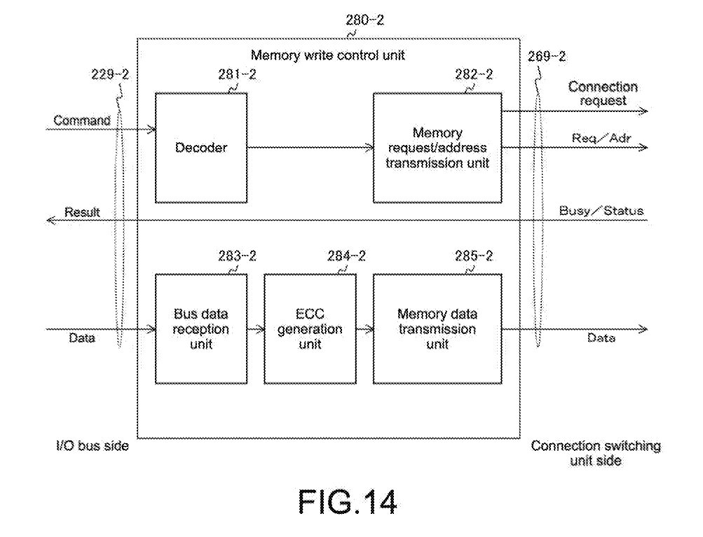

FIG. 14 is a diagram showing a configuration example of the memory write control unit 280-2 in the second embodiment of the present technology. The memory write control unit 280-2 includes a decoder 281-2, a memory request/address transmission unit 282-2, a bus data reception unit 283-2, an ECC generation unit 284-2, and a memory data transmission unit 285-2.

The units of the memory write control unit 280-2 have similar functions to the decoder 251, the memory request/address transmission unit 252, the bus data reception unit 253, the ECC generation unit 254, and the memory data transmission unit 255 in the first embodiment.

[Operation of Memory Controller]

In the second embodiment, when a command issued from the host computer 100 is a read command, the memory read control unit 280-1 performs request control to the memory 300, whereas when a command issued from the host computer 100 is a write command, the memory write control unit 280-2 performs request control to the memory 300. Other points except for the above are similar to those in the first embodiment, and detailed description thereof will thus be omitted.

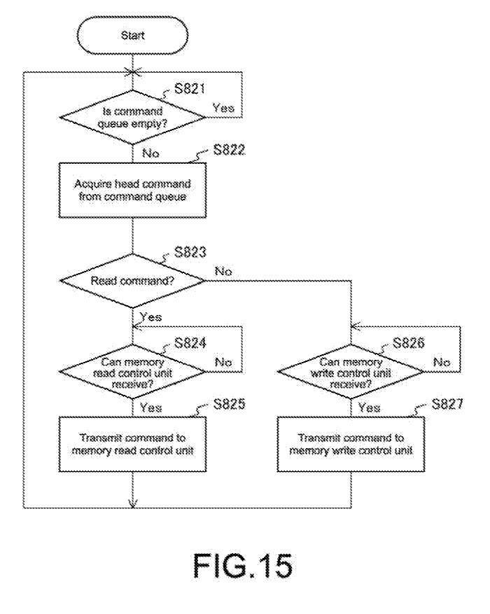

FIG. 15 is a sequence diagram showing a first processing procedure example of a storage interface control unit 210 in the second embodiment of the present technology. In the first processing procedure example, the storage interface control unit 210 includes one command queue of FIFO for holding commands received from the host computer 100. In other words, a read command and a write command are held in the command queue in the received order and sequentially taken out from the command previously received.

When the command queue is empty, the storage interface control unit 210 waits without change (Step S821: Yes). When the command queue is not empty (Step S821: No), the storage interface control unit 210 acquires a head command from the command queue (Step S822).

When the acquired command is a read command (Step S823: Yes) and when the memory read control unit 280-1 enters a state capable of receiving the next command (Step S824: Yes), the storage interface control unit 210 transmits the command to the memory read control unit 280-1 (Step S825). When the acquired command is a write command (Step S823: No) and when the memory write control unit 280-2 enters a state capable of receiving the next command (Step S826: Yes), the storage interface control unit 210 transmits the command to the memory write control unit 280-2 (Step S827).

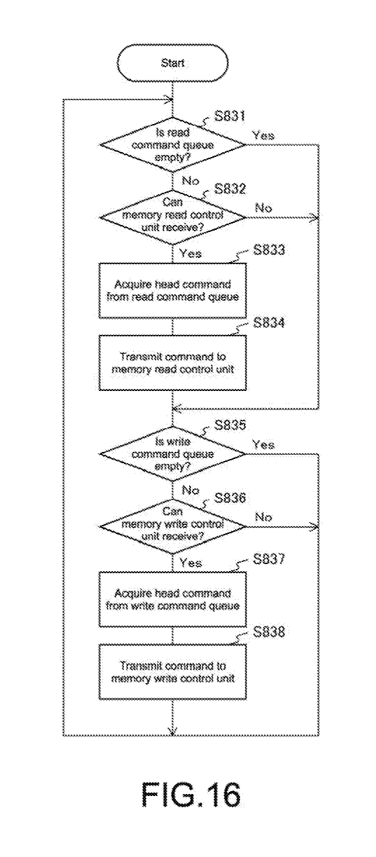

FIG. 16 is a sequence diagram showing a second processing procedure example of the storage interface control unit 210 in the second embodiment of the present technology. In the second processing procedure, the storage interface control unit 210 includes two command queues, a read command queue and a write command queue, of FIFO for holding commands received from the host computer 100. In other words, a read command is held in the read command queue in the received order and sequentially taken out from a read command previously received. Further, a write command is held in the write command queue in the received order and sequentially taken out from a write command previously received.

When the read command queue is not empty (Step S831: No) and when the memory read control unit 280-1 enters a state capable of receiving the next command (Step S832: Yes), the storage interface control unit 210 transmits the read command. In other words, the storage interface control unit 210 acquires a head read command from the read command queue (Step S833) and transmits the read command to the memory read control unit 280-1 (Step S834).

Next, when the write command queue is not empty (Step S835: No) and when the memory write control unit 280-2 enters a state capable of receiving the next command (Step S836: Yes), the storage interface control unit 210 transmits the write command. In other words, the storage interface control unit 210 acquires a head write command from the write command queue (Step S837) and transmits the write command to the memory write control unit 280-2 (Step S838).

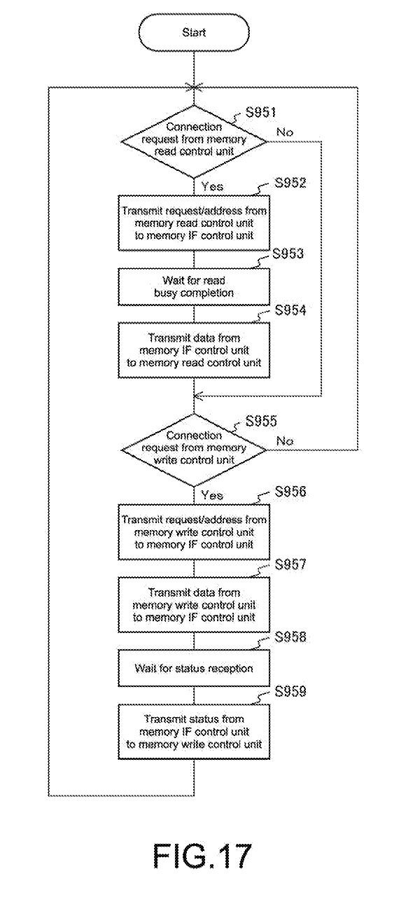

FIG. 17 is a sequence diagram showing a processing procedure example of a connection switching unit 260 in the second embodiment of the present technology.

First, when the connection determination unit 261 determines that a connection request from the memory read control unit 280-1 is received (Step S951: Yes), the memory read control unit 280-1 side of the switch 262 is selected. With this configuration, the request and address received from the memory read control unit 280-1 by the request/address reception units 263-1 are transmitted from the memory request/address transmission unit 264 to the memory interface control unit 270 (Step S952).

In this case, since the request is a read request, the connection determination unit 261 waits for read busy completion (Step S953). Subsequently, the read data transmitted from the memory interface control unit 270 is received by the memory data reception unit 267 and transmitted to the memory read control unit 280-1 via the data transmission unit 268-1 (Step S954).

Next, when the connection determination unit 261 determines that a connection request from the memory write control unit 280-2 is received (Step S955: Yes), the memory write control unit 280-2 side of the switch 262 is selected. With this configuration, the request and address received from the memory write control unit 280-2 by the request/address reception units 263-2 are transmitted from the memory request/address transmission unit 264 to the memory interface control unit 270 (Step S956).

In this case, since the request is a write request, the write data transmitted from the memory write control unit 280-2 is received by the data reception units 265-2. The write data is then transmitted to the memory interface control unit 270 via the memory data transmission unit 266 (Step S957). The connection determination unit 261 then waits for status reception from the memory interface control unit 270 (Step S958). Subsequently, when a status is received from the memory interface control unit 270, the connection determination unit 261 transmits the status to the memory write control unit 280-2 (Step S959).

As described above, according to the second embodiment of the present technology, providing the memory read control unit 280-1 and the memory write control unit 280-2 can improve a random access speed of the memory 300 while reducing the circuit size.

### 3. Third Embodiment

In the first embodiment described above, the two memory control units are provided, but the number of memory control units may be three or more. Hereinafter, an example of providing three or more memory control units will be described. It should be noted that the whole information processing system is similar to that of the first embodiment, and description thereof will thus be omitted.

[Configuration of Memory Controller]

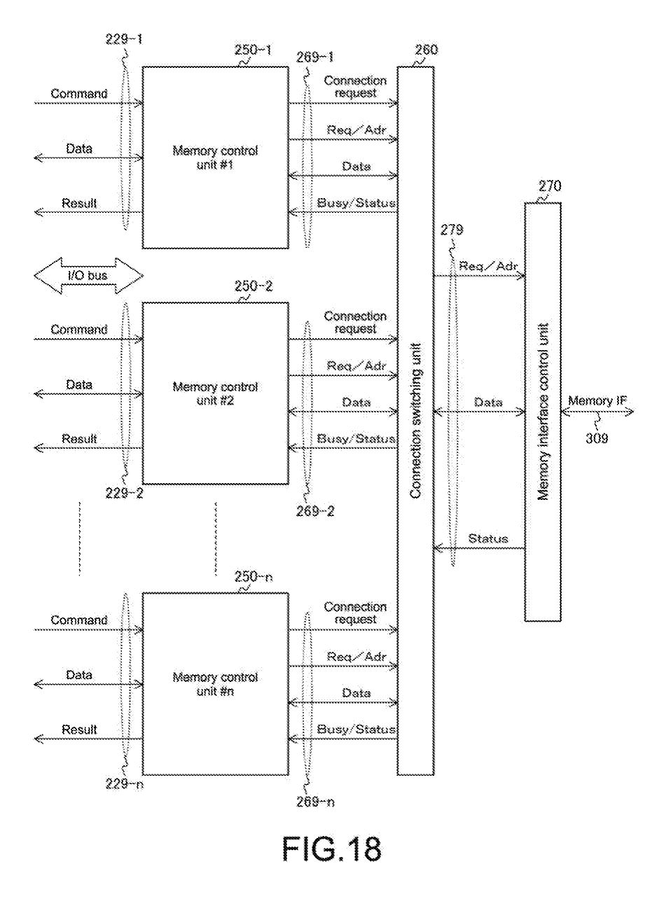

FIG. 18 is a diagram showing a configuration example of a memory control engine 201 in a third embodiment of the present technology. The memory control engine 201 in the third embodiment includes n (n is an integer of 3 or more) memory control units 250 and are each connected to the connection switching unit 260. Such a configuration is particularly effective when a processing time for processing in the memory control unit 250 has a large influence.

As described above, according to the third embodiment of the present technology, providing three or more memory control units 250 can improve a random access speed of the memory 300.

### 4. Fourth Embodiment

In a memory, a write time of a non-volatile memory particularly tends to be delayed by several times as large as a read time. In this regard, in a fourth embodiment, write is controlled to be performed independently and in parallel in each of non-volatile memories (dies, chips, or the like), so that write performance is improved. It should be noted that the whole information processing system is similar to that of the first embodiment, and description thereof will thus be omitted.

[Configuration of Memory Controller]

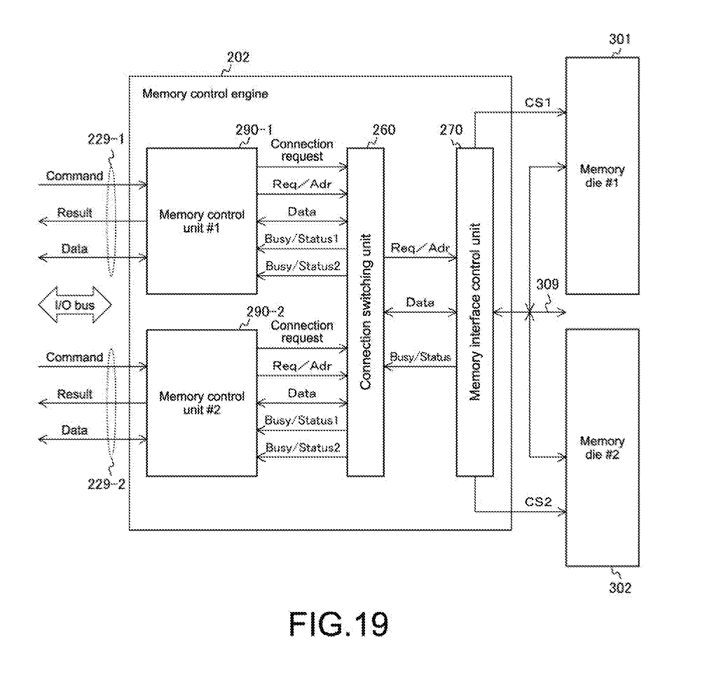

FIG. 19 is a diagram showing a configuration example of a memory control engine 202 in the fourth embodiment of the present technology. The memory control engine 202 in the fourth embodiment is connected to two memory dies 301 and 302 via the signal line 309. Chip selecting signals CS1 and CS2 from the memory interface control unit 270 specify which of the memory dies 301 and 302 is accessed.

Memory control units 290-1 and 290-2 of the fourth embodiment (hereinafter, collectively described as memory control units 290 in some cases) can perform write request control to the memory dies 301 and 302 in parallel. In other words, after a first write request is executed for one of the memory dies 301 and 302, a request signal with respect to the connection switching unit 260 is terminated, and a second write request can be immediately executed for the other one of the memory dies 301 and 302.

Therefore, each of the memory control units 290 is configured to receive and manage Busy/Status signals from the memory interface control unit 270 for each of the memory dies 301 and 302. When receiving status information from the memory dies 301 and 302, the status information indicating write completion, the memory control unit 290 clears write busy information. The next write request is not transmitted to the memory dies 301 and 302 being in a write busy state. Further, in order to check the status information with respect to the memory dies 301 and 302 being in the write busy state, the memory control unit 290 outputs a connection request to the connection switching unit 260, checks the status information, and then stops the connection request.

It should be noted that the memory dies 301 and 302 are each one example of a memory described in the Claims.

[Operation of Memory Controller]

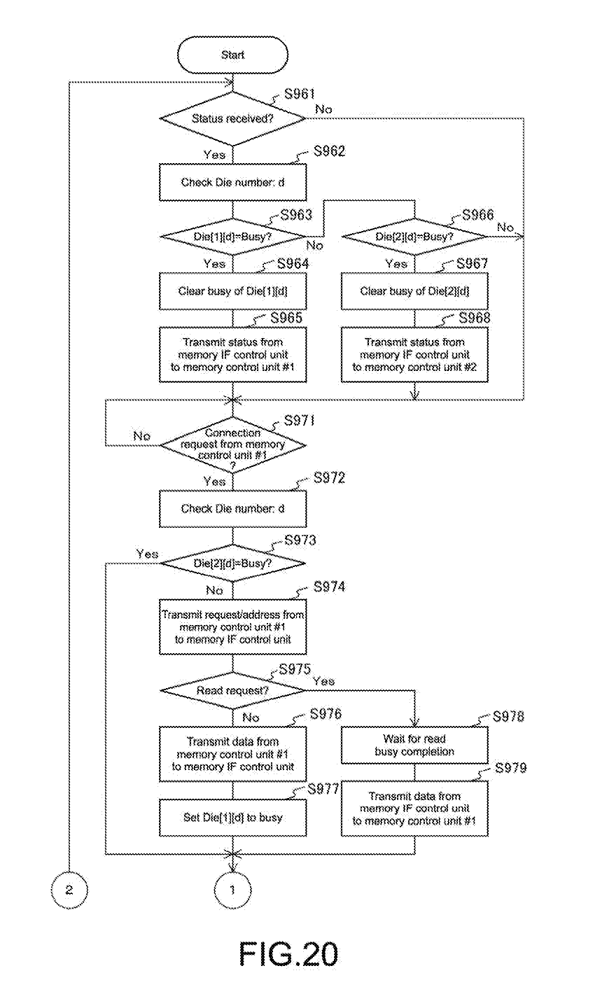

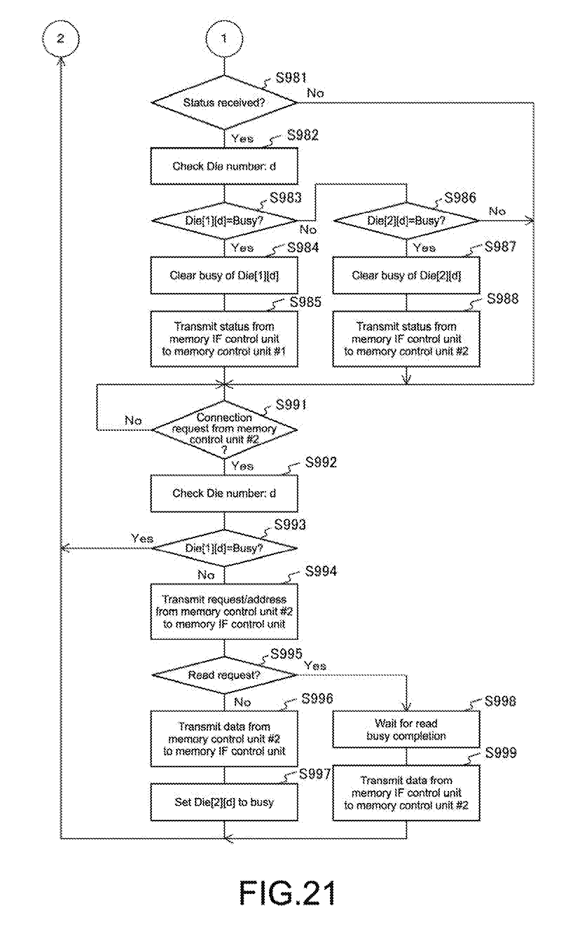

FIGS. 20 and 21 are sequence diagrams showing a processing procedure example of the connection switching unit 260 in the fourth embodiment of the present technology. It should be noted that in the figures, “Die[i][d]” is a busy signal when a memory control unit #i transmits a request and an address to a memory die #d. With this configuration, the connection switching unit 260 can return a status signal from the memory die 301 or 302 to a correct memory control unit 290.

When receiving a status from the memory die 301 or 302 via the memory interface control unit 270 (Step S961: Yes), the connection switching unit 260 checks a die number d (Step S962). When a memory die of the die number d is busy by the transmission from a memory control unit #1 (290-1) (Step S963: Yes), the busy is cleared (Step S964), and the status from the memory interface control unit 270 is transmitted to the memory control unit #1 (290-1) (Step S965). When a memory die of the die number d is busy by the transmission from a memory control unit #2 (290-2) (Step S966: Yes), the busy is cleared (Step S967), and the status from the memory interface control unit 270 is transmitted to the memory control unit #2 (290-2) (Step S968). It should be noted that when a status is not received from the memory dies 301 and 302 (Step S961: No), those processing are not performed.

Subsequently, when determining that a connection request from the memory control unit #1 (290-1) is received (Step S971: Yes), the connection determination unit 261 checks the die number d (Step S972). When the memory die of the die number d is not busy by the transmission from the memory control unit #2 (290-2) (Step S973: No), the memory control unit 290-1 side of the switch 262 is selected. With this configuration, the request and the address received by the request/address reception units 263-1 from the memory control unit 290-1 are transmitted from the memory request/address transmission unit 264 to the memory interface control unit 270 (Step S974). It should be noted that in a state where the memory die of the die number d is busy by the transmission from the memory control unit #1 (290-1), the next connection request is not transmitted from the memory control unit #1 (290-1). Thus, the transmission from the memory control unit #1 (290-1) is not considered here.

When the request from the memory control unit #1 (290-1) is a read request (Step S975: Yes), the connection determination unit 261 waits for read busy completion (Step S978). Subsequently, the read data transmitted from the memory interface control unit 270 is received by the memory data reception unit 267 and transmitted to the memory control unit #1 (290-1) via the data transmission units 268-1 (Step S979).

When the request from the memory control unit #1 (290-1) is a write request (Step S975: No), the write data transmitted from the memory control unit 290-1 is received by the data reception units 265-1. The write data is then transmitted to the memory interface control unit 270 via the memory data transmission unit 266 (Step S976). The memory die of the die number d by the transmission from the memory control unit #1 (290-1) is then set to busy (Step S977). It should be noted that the memory die of the die number d is originally busy (Step S973: Yes), the processing from Steps S974 to S979 are not performed.

Next, when receiving a status from the memory die 301 or 302 via the memory interface control unit 270 (Step S981: Yes), the connection switching unit 260 checks a die number d (Step S982). When a memory die of the die number d is busy by the transmission from the memory control unit #1 (290-1) (Step S983: Yes), the busy is cleared (Step S984), and the status from the memory interface control unit 270 is transmitted to the memory control unit #1 (290-1) (Step S985). When a memory die of the die number d is busy by the transmission from the memory control unit #2 (290-2) (Step S986: Yes), the busy is cleared (Step S987), and the status from the memory interface control unit 270 is transmitted to the memory control unit #2 (290-2) (Step S988). It should be noted that when a status is not received from the memory dies 301 and 302 (Step S981: No), those processing are not performed.

Subsequently, when determining that a connection request from the memory control unit #2 (290-2) is received (Step S991: Yes), the connection determination unit 261 checks the die number d (Step S992). When the memory die of the die number d is not busy by the transmission from the memory control unit #1 (290-1) (Step S993: No), the memory control unit 290-2 side of the switch 262 is selected. With this configuration, the request and the address received by the request/address reception units 263-2 from the memory control unit #2 (290-2) are transmitted from the memory request/address transmission unit 264 to the memory interface control unit 270 (Step S994). It should be noted that in a state where the memory die of the die number d is busy by the transmission from the memory control unit #2 (290-2), the next connection request is not transmitted from the memory control unit #2 (290-2). Thus, the transmission from the memory control unit #2 (290-2) is not considered here.

When the request from the memory control unit #2 (290-2) is a read request (Step S995: Yes), the connection determination unit 261 waits for read busy completion (Step S998). Subsequently, the read data transmitted from the memory interface control unit 270 is received by the memory data reception unit 267 and transmitted to the memory control unit #2 (290-2) via the data transmission units 268-2 (Step S999).

When the request from the memory control unit #2 (290-2) is a write request (Step S995: No), the write data transmitted from the memory control unit #2 (290-2) is received by the data reception units 265-2. The write data is then transmitted to the memory interface control unit 270 via the memory data transmission unit 266 (Step S996). The memory die of the die number d by the transmission from the memory control unit #2 (290-2) is then set to busy (Step S997). It should be noted that the memory die of the die number d is originally busy (Step S993: Yes), the processing from Steps S994 to S999 are not performed.

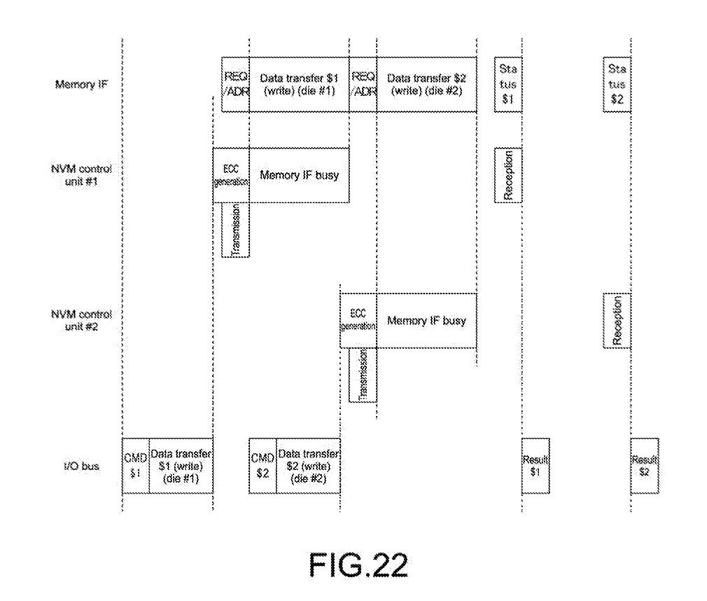

FIG. 22 is a diagram showing an operation timing example of the connection switching unit 260 in the fourth embodiment of the present technology. This is an example of a case where a former command is a write command for write in the memory die 301, and a subsequent command is a write command for write in the memory die 302.

The former write command is processed by the memory control unit 290-1. ECC is generated for the write data input from the I/O bus 220, and is transmitted from the memory interface control unit 270 to the memory die 301.

Subsequently, a status from the memory die 301 is output to the I/O bus 220 via the memory control unit 290-1.

The subsequent write command is processed by the memory control unit 290-2. ECC is generated for the write data input from the I/O bus 220, and is transmitted from the memory interface control unit 270 to the memory die 302.

Subsequently, a status from the memory die 302 is output to the I/O bus 220 via the memory control unit 290-2.

As described above, according to the fourth embodiment of the present technology, writing in the two memory dies 301 and 302 independently and in parallel can improve write performance. Further, performing read processing by using a write busy time can also improve read performance.

### 5. Fifth Embodiment

In the first to fourth embodiments described above, the example in which the ECC generation processing and the error detection/correction processing by the ECC are performed as data processing in the memory control unit has been described. In a fifth embodiment, an example of performing encryption and decryption processing will be described as an example of another data processing. It should be noted that the whole information processing system is similar to that of the first embodiment, and description thereof will thus be omitted.

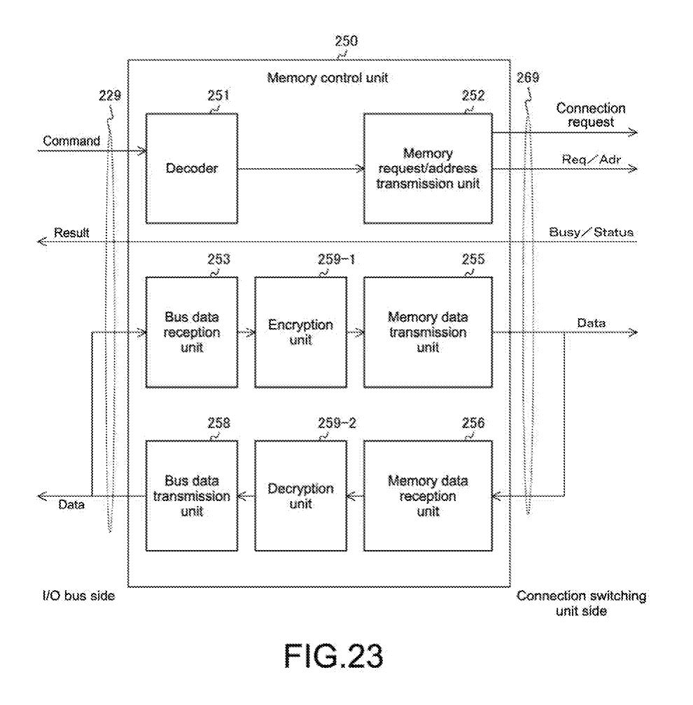

FIG. 23 is a diagram showing a configuration example of a memory control unit 250 in the fifth embodiment of the present technology. The memory control unit 250 in the fifth embodiment includes an encryption unit 259-1 instead of the ECC generation unit 254 in the first embodiment. Further, the memory control unit 250 in the fifth embodiment includes a decryption unit 259-2 instead of the error detection/correction unit 257 in the first embodiment.

The encryption unit 259-1 performs encryption processing on write data received by the bus data reception unit 253. It should be noted that the encryption unit 259-1 is an example of a write data processing unit described in the Claims.

The decryption unit 259-2 decrypts encrypted read data that is read from the memory 300. With this configuration, the data stored in the memory 300 is encrypted, so that security can be improved. It should be noted that the decryption unit 259-2 is an example of a read data processing unit described in the Claims.

As described above, according to the fifth embodiment of the present technology, the encryption and decryption processing can be assumed as the data processing in the memory control unit, and a random access speed of the memory 300 can be improved while improving security.

It should be noted that the embodiments described above are examples for embodying the present technology, and matters in the embodiments and matters specifying the invention in the Claims have respective correspondence relationships. Similarly, the matters specifying the invention in the Claims and matters in the embodiments of the present technology, which are denoted by names identical to the matters specifying the invention, have respective correspondence relationships. However, the present technology is not limited to the embodiments and can be embodied by variously modifying the embodiments without departing from the gist of the present technology.

Further, the processing procedures described in the above embodiments may be understood as a method including a series of those procedures. Alternatively, the processing procedures described in the above embodiments may be understood as a program for causing a computer to execute the series of procedures or as a recording medium storing that program. As the recording medium, for example, a CD (Compact Disc), an MD (Mini Disc), a DVD (Digital Versatile Disc), a memory card, and a Blu-ray (registered trademark) Disc can be used.

It should be noted that the effects described in this specification are merely exemplary ones and are not restrictive ones, and any other effects may be produced.

It should be noted that the present technology can have the following configurations.

(1) A memory controller, including:

memory control units that each independently generate a request to a memory on the basis of a command from a computer; and

a connection switching unit that connects any one of the memory control units and the memory in response to a connection request from each of the memory control units and outputs the request to the memory.

(2) The memory controller according to (1), in which

each of the memory control units includes
a read control unit that generates, as the request, a read request to the memory, and
a read data reception unit that receives read data from the memory, the read data corresponding to the read request.
   (3) The memory controller according to (2), in which

each of the memory control units further includes a read data processing unit that performs predetermined data processing on the read data.

(4) The memory controller according to claim 3, in which

the read data processing unit performs, as the predetermined data processing, error detection/correction processing of the read data.

(5) The memory controller according to (3), in which

the read data processing unit performs, as the predetermined data processing, decryption processing of the read data.

(6) The memory controller according to (1), in which

each of the memory control units includes
a write control unit that generates, as the request,
a write request to the memory, and a write data transmission unit that transmits write
data to the memory, the write data being related to the write request.
   (7) The memory controller according to (6), in which

each of the memory control units further includes a write data processing unit that performs predetermined data processing on the write data.

(8) The memory controller according to (7), in which

the write data processing unit performs, as the predetermined data processing, generation of an error correcting code of the write data.

(9) The memory controller according to (7), in which

the write data processing unit performs, as the predetermined data processing, encryption processing of the write data.

(10) The memory controller according to (1), in which

each of the memory control units includes any one of:
a read control unit that generates, as the request, a read request to the memory, and a read data reception unit that receives read data from the memory, the read data corresponding to the read request; and
a write control unit that generates, as the request, a write request to the memory, and a write data transmission unit that transmits write data to the memory, the write data being related to the write request.
   (11) A memory system, including:

a memory;

memory control units that each independently generate a request to the memory on the basis of a command from a computer; and

a connection switching unit that connects any one of the memory control units and the memory in response to a connection request from each of the memory control units and outputs the request to the memory.

(12) An information processing system, including:

a memory;

a computer;

memory control units that each independently generate a request to the memory on the basis of a command from the computer; and

a connection switching unit that connects any one of the memory control units and the memory in response to a connection request from each of the memory control units and outputs the request to the memory.

### REFERENCE SIGNS LIST

100 host computer
200 memory controller
201, 202 memory control engine
210 storage interface control unit
220 I/O bus
230 processor
250, 290 memory control unit
251, 281 decoder
252, 282 memory request/address transmission unit
253, 283-2 bus data reception unit
254, 284-2 ECC generation unit
255, 285-2 memory data transmission unit
256, 286-1 memory data reception unit
257, 287-1 error detection/correction unit
258, 288-1 bus data transmission unit
259-1 encryption unit
259-2 decryption unit
260 connection switching unit
261 connection determination unit
262 switch
263 request/address reception unit
264 memory request/address transmission unit
265 data reception unit
266 memory data transmission unit
267 memory data reception unit
268 data transmission unit
270 memory interface control unit
280-1 memory read control unit
280-2 memory write control unit
300 memory
301, 302 memory die
400 memory system

1. A memory controller, comprising:
memory control units that each independently generate a request to a memory on the basis of a command from a computer; and
a connection switching unit that connects any one of the memory control units and the memory in response to a connection request from each of the memory control units and outputs the request to the memory.

2. The memory controller according to claim 1, wherein
each of the memory control units includes
a read control unit that generates, as the request, a read request to the memory, and
a read data reception unit that receives read data from the memory, the read data corresponding to the read request.

3. The memory controller according to claim 2, wherein
each of the memory control units further includes a read data processing unit that performs predetermined data processing on the read data.

4. The memory controller according to claim 3, wherein
the read data processing unit performs, as the predetermined data processing, error detection/correction processing of the read data.

5. The memory controller according to claim 3, wherein
the read data processing unit performs, as the predetermined data processing, decryption processing of the read data.

6. The memory controller according to claim 1, wherein
each of the memory control units includes a write control unit that generates, as the request, a write request to the memory, and
a write data transmission unit that transmits write data to the memory, the write data being related to the write request.

7. The memory controller according to claim 6, wherein
each of the memory control units further includes a write data processing unit that performs predetermined data processing on the write data.

8. The memory controller according to claim 7, wherein
the write data processing unit performs, as the predetermined data processing, generation of an error correcting code of the write data.

9. The memory controller according to claim 7, wherein
the write data processing unit performs, as the predetermined data processing, encryption processing of the write data.

10. The memory controller according to claim 1, wherein
each of the memory control units includes any one of:
a read control unit that generates, as the request, a read request to the memory, and a read data reception unit that receives read data from the memory, the read data corresponding to the read request; and
a write control unit that generates, as the request, a write request to the memory, and a write data transmission unit that transmits write data to the memory, the write data being related to the write request.

11. A memory system, comprising:
a memory;
memory control units that each independently generate a request to the memory on the basis of a command from a computer; and
a connection switching unit that connects any one of the memory control units and the memory in response to a connection request from each of the memory control units and outputs the request to the memory.

12. An information processing system, comprising:
a memory;
a computer;
memory control units that each independently generate a request to the memory on the basis of a command from the computer; and
a connection switching unit that connects any one of the memory control units and the memory in response to a connection request from each of the memory control units and outputs the request to the memory.
